(19) United States
(12) Patent Application Publication
(10) Pub. No.: US 2025/0386287 A1
(43) Pub. Date: Dec. 18, 2025

(54) SYSTEM AND METHOD FOR INTEGRATING NETWORK SLICING ENTITY WITH NETWORK FUNCTIONS IN WIRELESS NETWORK

(71) Applicant: JIO PLATFORMS LIMITED, Ahmedabad (IN)

(72) Inventors: Aayush BHATNAGAR, Navi Mumbai (IN); Aditya GUPTA, Karnal (IN); Apoorva KHAMESRA, Udaipur (IN); Tarun MAHESHWARI, Pune (IN)

(73) Assignee: JIO PLATFORMS LIMITED, Ahmedabad (IN)

(21) Appl. No.: 18/879,394

(22) PCT Filed: Aug. 18, 2023
(86) PCT No.: PCT/IB2023/058272

§ 371 Date: Dec. 27, 2024

(30) Foreign Application Priority Data
Aug. 22, 2022 (IN) 202221047589

(51) Int. Cl. H04W 48/18; H04W 8/18; H04W 84/04

(52) U.S. Cl. CPC H04W 48/18; H04W 8/183; H04W 84/042

(57) ABSTRACT

The present disclosure relates to a system and a method for integrating a network slicing entity with Network Functions (NFs) in a wireless network. The system receives an input comprising a plurality of parameters from the network slicing entity associated with a computing device. The system performs provisioning of Network Slice Selection Function (NSSF) for slice configuration, and receives provisioning response from the NSSF. The system performs in-sequence provisioning of Session Management Function (SMF) and Access and Mobility Management Function (AMF), and receives provisioning responses from the SMF and the AMF based on the provisioning response received from the NSSF indicating success. The system integrates the network slicing entity with the NSSF, the SMF, and the AMF to enable the network slicing entity to generate a plurality of network slices based on the provisioning responses received from the SMF and AMF.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to internetworking technologies. More particularly, the present disclosure relates to a system and a method for integrating a network slicing entity with one or more Network Functions (NFs) in a wireless network.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In general, network slicing is a network architecture that enables multiplexing of virtualized and independent logical networks on a same physical network infrastructure. On the same physical network infrastructure, network slicing enables enterprises to support various application needs for security, dependability, and performance. Network slicing uses automation, Network Function Virtualization (NFV), and Software-Defined Networking (SDN) to quickly divide the network and its resources to accommodate different applications, devices, domains, and groups. Enterprises meet Service Level Agreements (SLAs), and guarantee that each application obtains the resources it requires continually by implementing the network slicing.

Further, the network slicing enables companies to more finely regulate traffic resources in a cellular world. Each traffic slice has different resource needs, Quality of Service (QOS) requirements, security setups, and latency specifications. For instance, a network slice used to monitor an Internet of Things (IoT) lighting system may differ from one supporting high-definition streaming video. However, the existing network slicing methods and Network Functions (NFs) integrating methods has the problems of network rigidity, degradation of performance, and the like.

There is, therefore, a need in the art to provide a system and a method for network slicing with improved performance by overcoming the deficiencies of the prior arts.

### Objects of the Present Disclosure

Some of the objects of the present disclosure, which at least one embodiment herein satisfies are as listed herein below.

It is an object of the present disclosure to provide a system and a method for integrating a network slicing entity with one or more Network Functions (NFs) in a wireless network.

It is an object of the present disclosure to standardize a plurality of parameters required for network slicing, and tune/configure the plurality of parameters during the network slicing.

It is an object of the present disclosure to provide a system and method for network slicing by integrating the network slicing entity with a Network Slicing Selection Function (NSSF), an Access and Mobility Management Function (AMF), a Session Management Function (SMF), a Policy Control Function (PCF), and the like.

It is an object of the present disclosure to assist in creation of slice service specific configuration in the network.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for integrating a network slicing entity with one or more Network Functions (NFs) in a wireless network. The system includes one or more processors, and a memory operatively coupled to the one or more processors. The memory includes processor-executable instructions, which on execution, cause the one or more processors to receive an input including a plurality of parameters from a network slicing entity associated with a computing device, perform provisioning of Network Slice Selection Function (NSSF) for slice configuration, and receive provisioning response from the NSSF, based on the plurality of parameters comprised in the received input, perform in-sequence provisioning of Session Management Function (SMF) and Access and Mobility Management Function (AMF), and receive provisioning responses from the SMF and the AMF based on the provisioning response received from the NSSF indicating success, and integrate the network slicing entity with the NSSF, the SMF, and the AMF to enable the network slicing entity to generate a plurality of network slices based on the provisioning responses received from the SMF and AMF.

In an embodiment, the plurality of parameters may include at least one of: a Network Slice Selection Assistance Information (NSSAI), a Public Land Mobile Network (PLMN), a Tracking Area Code (TAC), a Tracking Area List (TAL), a Data Network Name (DNN), a Unified Data Management (UDM) template name, a restriction status, and a Network Slice Identifier (NSID) list.

In an embodiment, the memory includes processor-executable instructions, which on execution, may cause the one or more processors to fetch information pertaining to interruption from a user interface associated with the system based on the provisioning response received from the NSSF indicating a failure.

In an embodiment, the memory includes processor-executable instructions, which on execution, may cause the one or more processors to separately perform Move, Add, Change, or Delete (MACD) functions for the NSSF, the SMF, the AMF, and a UDM.

In an embodiment, the one or more processors may perform the MACD functions for the NSSF by performing at least one of: adding a slice per Tracking Area Identity (TAI), creating a NSSAI mapping, enabling slice restriction for a roamer, enabling configured NSSAI provisioning, and providing supported Home Public Land Mobile Network (HPLMN) list and slice information.

In an embodiment, the one or more processors may perform the MACD functions for the UDM using at least one of: a NSSAI, AMF subscription data, DNN configuration data, a DNN configuration map, SMF select data, a Communication Service (CoS) name, a Visited Public Land Mobile Network (VPLMN) list, a subscription profile, and template subscriber management data.

In an embodiment, the provisioning response received from the NSSF, and the provisioning responses received from the SMF and the AMF may include at least one of: a notification Uniform Resource Identifier (URI), a correlation Identifier (ID), and PLMN slice information.

In an embodiment, the one or more processors may enable the network slicing entity to generate the plurality of network slices by being configured to create a subscriber provisioning template for a specific slice which is used to provision one or more subscribers in a UDM or a Unified Data Repository (UDR), provide slice information mapped with Public Land Mobile Network (PLMN) and Tracking Area Identity (TAI) information to the NSSF based on the subscriber provisioning template, provide the slice information to the SMF and the AMF in response to providing the slice information to the NSSF, and generate the plurality of network slices once the provision of the slice information to the SMF and the AMF is complete.

In an aspect, the present disclosure relates to a method for integrating a network slicing entity with a plurality of Network Functions (NF) in a wireless network. The method includes receiving, by a processor associated with a system, an input comprising a plurality of parameters from a network slicing entity associated with a computing device, performing, by the processor, provisioning of Network Slice Selection Function (NSSF) for slice configuration, and receiving provisioning response from the NSSF, based on the plurality of parameters comprised in the received input, performing, by the processor, in-sequence provisioning of Session Management Function (SMF) and Access and Mobility Management Function (AMF), and receiving provisioning responses from the SMF and the AMF based on the provisioning response received from the NSSF indicating success, and integrating, by the processor, the network slicing entity with the NSSF, the SMF, and the AMF to enable the network slicing entity to generate a plurality of network slices based on the provisioning responses received from the SMF and AMF.

In an embodiment, the plurality of parameters may include at least one of: a Network Slice Selection Assistance Information (NSSAI), a Public Land Mobile Network (PLMN), a Tracking Area Code (TAC), a Tracking Area List (TAL), a Data Network Name (DNN), a UDM template name, a restriction status, and a Network Slice Identifier (NSID) list.

In an embodiment, the method may include fetching information pertaining to interruption from a user interface associated with the system based on the provisioning response received from the NSSF indicating a failure.

In an embodiment, the method may include separately performing Move, Add, Change, or Delete (MACD) functions for the NSSF, the SMF, the AMF, and a UDM.

In an embodiment, performing the MACD functions for the NSSF comprises at least one of: adding a slice per Tracking Area Identity (TAI), creating a Network Slice Selection Assistance Information (NSSAI) mapping, enabling slice restriction for a roamer, enabling configured NSSAI provisioning, and providing supported Home Public Land Mobile Network (HPLMN) list and slice information.

In an embodiment, performing the MACD functions for the UDM includes using at least one of: Network Slice Selection Assistance Information (NSSAI), AMF subscription data, Data Network Name (DNN) configuration data, a DNN configuration map, SMF select data, a Communication Service (CoS) name, a Visited Public Land Mobile Network (VPLMN) list, a subscription profile, and template subscriber management data.

In an embodiment, the provisioning response received from the NSSF, and the provisioning responses received from the SMF and the AMF may include at least one of: a notification Uniform Resource Identifier (URI), a correlation Identifier (ID), and a PLMN slice information.

In an embodiment, enabling the network slicing entity to generate the plurality of network slices may include creating, by the processor, a subscriber provisioning template for a specific slice which is used to provision one or more subscribers in a UDM or a Unified Data Repository (UDR), providing, by the processor, slice information mapped with Public Land Mobile Network (PLMN) and Tracking Area Identity (TAI) information to the NSSF based on the subscriber provisioning template, providing, by the processor, the slice information to the SMF and the AMF in response to providing the slice information to the NSSF, and generating, by the processor, the plurality of network slices once the provision of the slice information to the SMF and the AMF is complete.

In an aspect, the present disclosure relates to a non-transitory computer-readable medium including processor-executable instructions that cause a processor to receive an input comprising a plurality of parameters from a network slicing entity associated with a computing device, perform provisioning of Network Slice Selection Function (NSSF) for slice configuration, and receive provisioning response from the NSSF, based on the plurality of parameters comprised in the received input, perform in-sequence provisioning of Session Management Function (SMF) and Access and Mobility Management Function (AMF), and receive provisioning responses from the SMF and the AMF based on the provisioning response received from the NSSF indicating success, and integrate the network slicing entity with the NSSF, the SMF, and the AMF to enable the network slicing entity to generate a plurality of network slices based on the provisioning responses received from the SMF and the AMF.

### BRIEF DESCRIPTION OF THE DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

The diagrams are for illustration only, which thus is not a limitation of the present disclosure, and wherein:

FIG. 1 illustrates an exemplary network architecture (100) in which or with which proposed system (110) of the present disclosure may be implemented, in accordance with an embodiment of the present disclosure.

FIG. 2 illustrates an exemplary block diagram (200) of the system (110), in accordance with an embodiment of the present disclosure.

FIG. 3 illustrates an exemplary representation (300) of a network slice architecture, in accordance with embodiments of the present disclosure.

FIG. 4 illustrates an exemplary flow diagram (400) of a global slice provisioning process for 5^{th} Generation Network Function (5GNF), in accordance with embodiments of the present disclosure.

FIG. 5 illustrates an exemplary representation (500) of an end-to-end network slicing architecture, in accordance with embodiments of the present disclosure.

FIG. 6 illustrates an exemplary block diagram (600) of a generic slice creation flow, in accordance with embodiments of the present disclosure.

FIG. 7 illustrates an exemplary flow diagram (700) of network slice provisioning in 5G core network nodes through a network slicing entity (NSP), in accordance with embodiments of the present disclosure.

FIG. 8 illustrates an exemplary representation (800) of an advanced network slice architecture, in accordance with embodiments of the present disclosure.

FIG. 9A illustrates an exemplary flow diagram (900A) of Session Management Function (SMF) and Network Slice Selection Assistance Information (NSSAI) create functions, in accordance with embodiments of the present disclosure.

FIG. 9B illustrates an exemplary flow diagram (900B) of the SMF and the NSSAI view functions, in accordance with embodiments of the present disclosure.

FIG. 9C illustrates an exemplary flow diagram (900C) of the SMF and the NSSAI delete functions, in accordance with embodiments of the present disclosure.

FIG. 10 illustrates an exemplary block diagram (1000) of the NSSF and Move, Add, Change, or Delete (MACD) flow, in accordance with embodiments of the present disclosure.

FIG. 11 illustrates an exemplary block diagram (1100) of a subscriber provisioning flow, in accordance with embodiments of the present disclosure.

FIG. 12 illustrates an exemplary flow diagram (1200) of enterprise onboarding and subscriber provisioning workflow, in accordance with embodiments of the present disclosure.

FIG. 13 refers to an exemplary computer system (1300) in which or with which embodiments of the present disclosure may be utilized, in accordance with embodiments of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure describes an interface, for example, a Fulfilment Management System (FMS) to integrate with a plurality of Network Functions (NFs), which include but not limited to, a Network Slicing Selection Function (NSSF), an Access and Mobility Management Function (AMF), a Session Management Function (SMF), and a Policy Control Function (PCF). A network slicing entity, for example, a Network Slicing Portal (NSP) may communicate with the FMS which is integrated with the NFs, and further the NFs may be integrated with the NSP for provisioning. The terms network slicing entity and the NSP may be used interchangeably throughout the description.

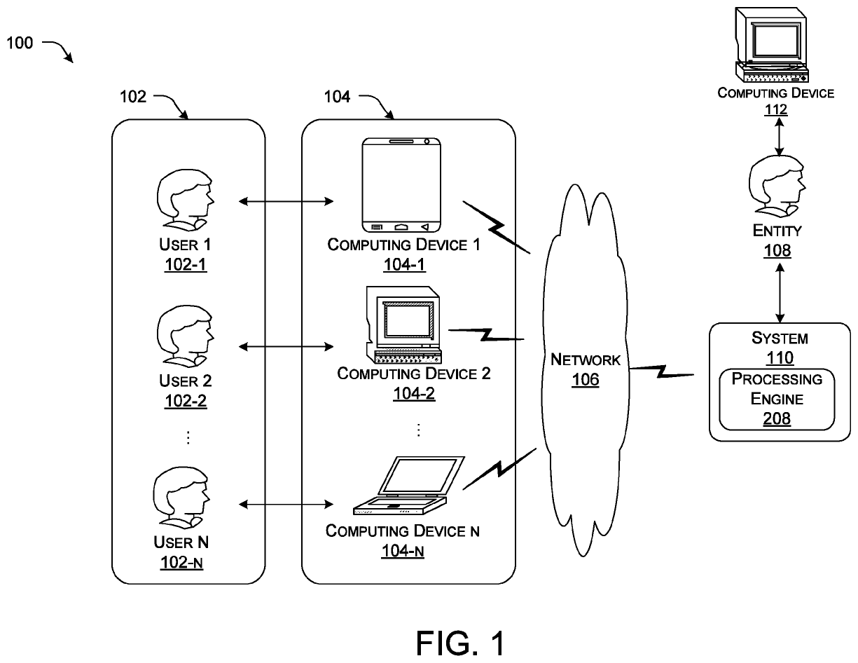

Various embodiments of the present disclosure will be explained in detail with reference to FIGS. 1-13.

FIG. 1 illustrates an exemplary network architecture (100) in which or with which proposed system may be implemented, in accordance with an embodiment of the present disclosure.

As illustrated in FIG. 1, by way of example and not by not limitation, the exemplary network architecture (100) may include a plurality of computing devices (104-1, 104-2 . . . 104-N), which may be individually referred as the computing device (104) and collectively referred as the computing devices (104). The plurality of computing devices (104) may include, but not be limited to, scanners such as cameras, webcams, scanning units, and the like configured to send a request or an input including a plurality of parameters to a system (110).

In an embodiment, the computing device (104) may include smart devices operating in a smart environment, for example, an Internet of Things (IoT) system. In such an embodiment, the computing device (104) may include, but is not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users and/or entities, or any combination thereof.

A person of ordinary skill in the art will appreciate that the computing device or user equipment (104) may include, but is not limited to, intelligent, multi-sensing, network-connected devices, that can integrate seamlessly with each other and/or with a central server or a cloud-computing system or any other device that is network-connected.

In an embodiment, the user equipment (104) may include, but is not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the user equipment (104) may include, but is not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the user equipment (104) may include one or more in-built or externally coupled accessories including, but not limited to, a visual aid device such as a camera, an audio aid, a microphone, a keyboard, and input devices for receiving input from the user or the entity such as touch pad, touch enabled screen, electronic pen, and the like.

A person of ordinary skill in the art will appreciate that the user equipment (104) may not be restricted to the mentioned devices and various other devices may be used.

In an exemplary embodiment, the user equipment (104) may communicate with the system (110), for example, a Fulfilment Management System (FMS), through a network (106). The network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. A network (106) may include, by way of example but not limitation, one or more of: a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, some combination thereof.

In an embodiment, the network architecture (100) may include a system (110), for example, the FMS. The system (110) may be associated with an entity (108), for example, a network slicing entity.

In an embodiment, the system (110) may act as an interface to receive an input including a plurality of parameters from the network slicing entity (108). The network slicing entity (108) may be associated with a computing device (112). The system (110) may perform provisioning of Network Slice Selection Function (NSSF) for slice configuration, and receive provisioning response from the NSSF, based on the plurality of parameters comprised in the received input. The system (110) may perform in-sequence provisioning of Session Management Function (SMF) and Access and Mobility Management Function (AMF), and receive provisioning responses from the SMF and the AMF based on the provisioning response received from the NSSF indicating success. The system (110) may integrate the network slicing entity (108) with the NSSF, the SMF, and the AMF to enable the network slicing entity (108) to generate a plurality of network slices based on the provisioning responses received from the SMF and AMF.

In an exemplary embodiment, the system (110) may be configured to standardize the plurality of parameters required for network slicing, and tune/configure the plurality of parameters during network slicing.

In an exemplary embodiment, the network (106) may include, by way of example but not limitation, at least a portion of one or more networks (106) having one or more nodes that transmit, receive, forward, generate, buffer, store, route, switch, process, or a combination thereof, etc. one or more messages, packets, signals, waves, voltage or current levels, some combination thereof, or so forth. The network (106) may include, by way of example but not limitation, one or more of: a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, some combination thereof.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

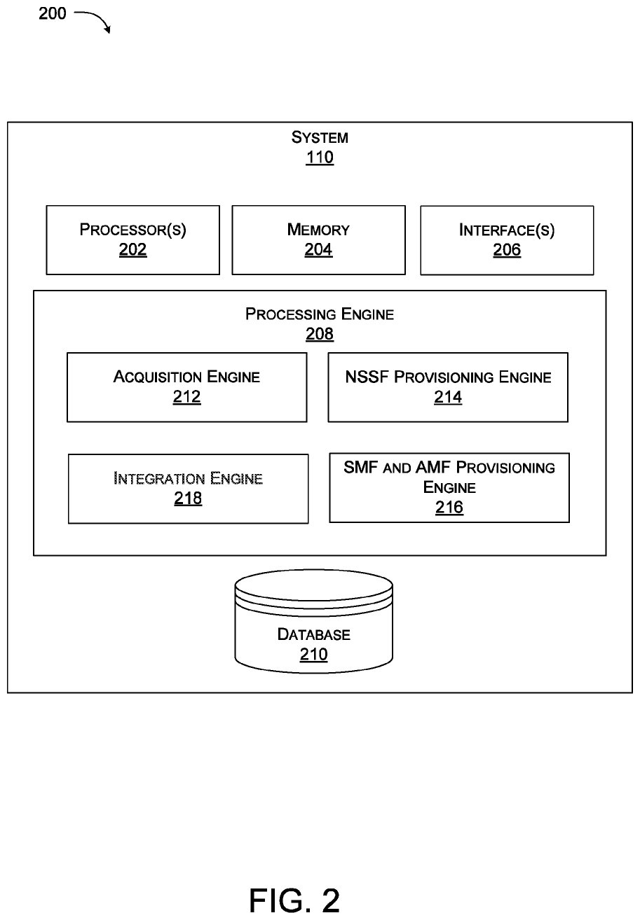

FIG. 2 illustrates an exemplary block diagram (200) of the FMS (110), in accordance with an embodiment of the present disclosure.

In an embodiment, and as shown in FIG. 2, the FMS (110) may include one or more processors (202). The one or more processors (202) may be implemented as one or more microprocessors, microcomputers, microcontrollers, digital signal processors, central processing units, logic circuitries, and/or any devices that manipulate data based on operational instructions. Among other capabilities, the one or more processor(s) (202) may be configured to fetch and execute computer-readable instructions stored in a memory (204) of the FMS (110). The memory (204) may store one or more computer-readable instructions or routines, which may be fetched and executed to create or share the data units over a network service. The memory (204) may comprise any non-transitory storage device including, for example, volatile memory such as Random-Access Memory (RAM), or non-volatile memory such as Erasable Programmable Read-Only Memory (EPROM), flash memory, and the like.

In an embodiment, the FMS (110) may also comprise an interface(s) (206). The interface(s) (206) may comprise a variety of interfaces, for example, a variety of interfaces, for example, interfaces for data input and output devices, referred to as I/O devices, storage devices, and the like. The interface(s) (206) may facilitate communication of the FMS (110) with various devices coupled to it. The interface(s) (206) may also provide a communication pathway for one or more components of the FMS (110). Examples of such components include, but are not limited to, processing engine(s) (208) and a database (210).

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the one or more processors (202) may comprise a processing resource (for example, one or more processors), to execute such instructions. In the present examples, the machine-readable storage medium may store instructions that, when executed by the processing resource, implement the processing engine(s) (208). In such examples, the FMS (110) may comprise the machine-readable storage medium storing the instructions and the processing resource to execute the instructions, or the machine-readable storage medium may be separate but accessible to the FMS (110) and the processing resource. In other examples, the processing engine(s) (208) may be implemented by electronic circuitry.

In an exemplary embodiment, the processing engine(s) (208) may include one or more engines selected from any of an acquisition engine (212), a NSSF provisioning engine (214), a SMF and AMF provisioning engine (216), and an integration engine (218).

In an embodiment, the acquisition engine (212) may receive an input comprising a plurality of parameters from a network slicing entity (108) associated with the computing device (112). The plurality of parameters, may include but not limited to, a Network Slice Selection Assistance Information (NSSAI), a Public Land Mobile Network (PLMN), a Tracking Area Code (TAC), a Tracking Area List (TAL), a Data Network Name (DNN), a Unified Data Management (UDM) template name, a restriction status, and a Network Slice Identifier (NSID) list.

In an embodiment, the NSSF provisioning engine (214) may perform provisioning of the NSSF for slice configuration, and receive provisioning response from the NSSF, based on the plurality of parameters included in the received input.

In an embodiment, the SMF and AMF provisioning engine (216) may perform in-sequence provisioning of the SMF and the AMF, and receive provisioning responses from the SMF and the AMF based on the provisioning response received from the NSSF indicating success. In case if the provisioning response received from the NSSF indicates a failure, the SMF and AMF provisioning engine (216) may fetch information pertaining to interruption from a user interface associated with the system.

In an embodiment, the provisioning response received from the NSSF, and the provisioning responses received from the SMF and the AMF may include, but not limited to, a notification Uniform Resource Identifier (URI), a correlation Identifier (ID), and PLMN slice information.

In an embodiment, the integration engine (218) may integrate the network slicing entity (108) with the NSSF, the SMF, and the AMF and enable the network slicing entity (108) to generate a plurality of network slices based on the provisioning responses received from the SMF and AMF. The plurality of network slices may be generated by: creating a subscriber provisioning template for a specific slice which is used to provision one or more subscribers in the UDM or a Unified Data Repository (UDR), providing slice information mapped with the PLMN and a Tracking Area Identity (TAI) information to the NSSF based on the subscriber provisioning template, and providing the slice information to the SMF and the AMF in response to providing the slice information to the NSSF. The plurality of network slices may be generated once the provision of the slice information to the SMF and the AMF is complete.

In an embodiment, the database (210) may comprise data that may be either stored or generated as a result of functionalities implemented by any of the components of the processor(s) (202) or the processing engine(s) (208) or the system (110).

Although FIG. 2 shows exemplary components of the FMS (110), in other embodiments, the FMS (110) may include fewer components, different components, differently arranged components, or additional functional components than depicted in FIG. 2. Additionally, or alternatively, one or more components of the FMS (110) may perform functions described as being performed by one or more other components of the FMS (110).

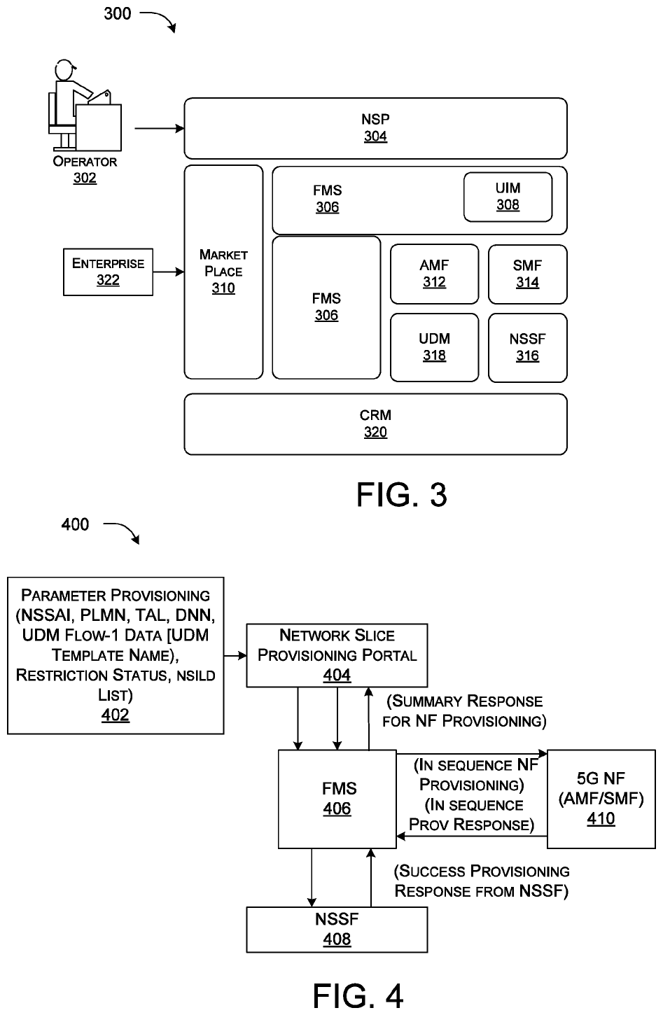

FIG. 3 illustrates an exemplary representation (300) of a network slice architecture, in accordance with embodiments of the present disclosure.

Referring to FIG. 3, the network slice architecture may include an entity, for example but not limited to, a network slicing entity (304) and an enterprise (322). The network slicing entity (304) may be a network slicing portal (NSP). The network slicing entity (304) may be operated by a user/operator (302) associated with the network slicing entity (304).

In an embodiment, the network slice architecture may include an FMS (306) associated with a User Identity Module (UIM) (308). The network slice architecture may also include a plurality of NFs. The plurality of NFs may include, but not limited to, an AMF (312), a SMF (314), a NSSF (316), and a UDM (318). Further, the network slice architecture may include a market place (310), and a customer relationship management (CRM) (320). The enterprise (322) may be associated with the market place (310).

In an embodiment, the network slicing entity (304) may support the following functionalities:
Creation of network slice workflow for the AMF (312), the SMF (314), the NSSF (316) via the FMS (306),
Perform NSSF MACD functions,
Perform UDM MACD functions, and
Perform AMF/SMF MACD functions.

In an embodiment, the network slicing entity (304) may enable the user/operator (302) to create, view, and delete one or more parameters of the NSSF (316). Application Programming Interface (API) may be exposed by the NSSF (316) towards the network slicing entity (304) to perform MACD operations from network slicing entity (304) user interface. The NSSF MACD operations may be performed by: adding slice per TAI, creating NSSAI mapping, performing slice restriction for roamer, performing configured NSSAI provisioning, and providing supported Home Public Land Mobile Network (HPLMN) list and slice information.

In an embodiment, the network slicing entity (304) may enable the user/operator (302) to create, view, and delete one or more parameters of the UDM. The one or more parameters include, but not limited to, the NSSAI, AMF subscription data, DNN configuration data, a DNN configuration map, SMF select data, a Communication Service (CoS) name, a Visited Public Land Mobile Network (VPLMN) list, a subscription profile, and template subscriber management data.

In an embodiment, the network slicing entity (304) may enable the user/operator (302) to separately create, view, and delete one or more parameters of the AMF (312) and the SMF (314). The one or more parameters of the AMF (312) and the SMF (314) may include, but not limited to, the NSSAI.

FIG. 4 illustrates an exemplary flow diagram (400) of a global slice provisioning process for 5^{th} Generation Network Function (5GNF), in accordance with embodiments of the present disclosure.

Referring to FIG. 4, a network slicing entity (404) which may be a network slice provisioning portal may receive an input including the plurality of parameters (402), for example but not limited to, the NSSAI, the PLMN, the TAC (TAL or TAC range), the DNNs, the UDM template name, the restriction status, and the NSID list from a user interface (UI). The UDM template may be removed from the input based on the user requirement. The DNN, the TAL, and the NSID List may be in an array format. For tracking individual work flow, the network slicing entity (404) may pass a unique order Identifier (ID) for each input. For providing valid NSID list values, the UI may also send PLMN information as GET API for the NSSF which may be used by the FMS (406) to identify the NSSF, and get NSID list from the NSSF.

The FMS (406) may receive the input including the plurality of parameters (402) from the network slicing entity (404). The FMS (406) may store the received data, and proceed with provisioning of the NSSF (408). Multiple API calls may be required for provisioning “slice per TAI” API from a NSSF provisioning guide. Additional API calls may also be required for provisioning “configured NSSAI provisioning” and “restricted per TAI” for which additional parameters may be passed, which may be a part of MACD operations. The NSSF (408) may send provisioning response indicating success or failure to the FMS (406).

Based on successful response received from the NSSF (408) for slice configuration, the FMS (406) may proceed with provisioning of the SMF/AMF (410) in sequence. The SMF/AMF (410) may send the provisioning responses to the FMS (406). The network slicing entity (404) may get a summary of provisioning responses or a specific order from the FMS (406) by calling corresponding API created by the FMS (406).

In case the summary response indicates failure, the user may need to login to the FMS UI for fetching information pertaining to interruption from the FMS UI and perform manual retry for the interrupted workflow.

Retry from the FMS (406) may be considered from the NSSF (408) for API requests in case 500 response code (HyperText Transfer Protocol (HTTP) header) is received or in case of timeout of request/failure to establish connection.

Retry from the FMS (406) may be considered for the AMF/SMF (410) for API requests in case of 500 response code (JavaScript Object Notation (JSON) body) is received or in case of timeout of request/failure to establish connection.

Separate MACD operations may be performed for NSSF (408), and SMF/AMF (410). It is assumed that for NSSF (408), the MACD operations via network slicing entity (404) may be already built, thus the MACD operations for the NSSF (408) may be already handled.

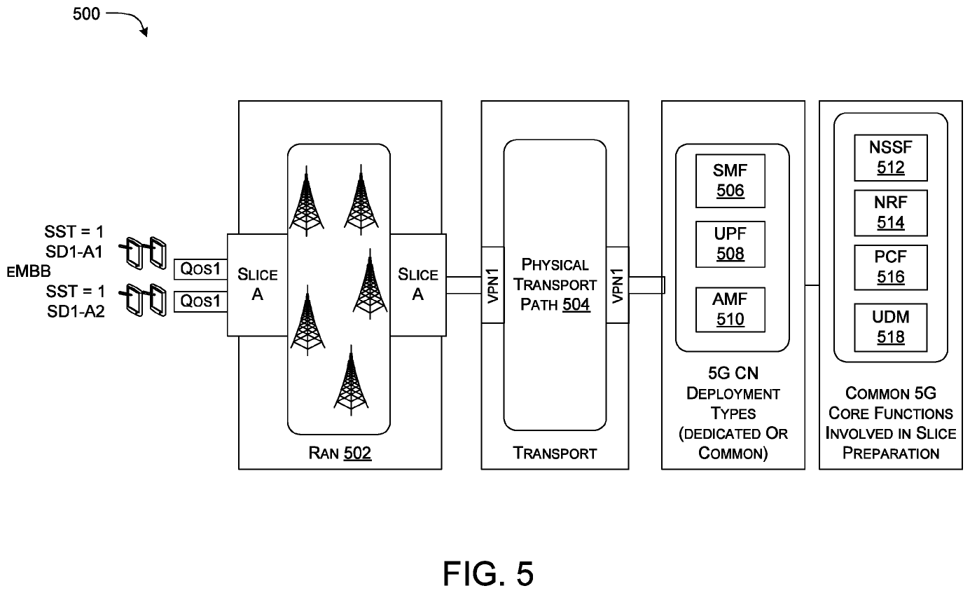

FIG. 5 illustrates an exemplary representation (500) of an end-to-end network slicing architecture, in accordance with embodiments of the present disclosure.

Referring to FIG. 5, the network slicing architecture may be a combination of sub-network instances that may be combined to create end-to-end services. The network slicing architecture may allow flexibility by creating multiple virtual and logical networks on top of a common shared physical infrastructure configured to support specific industry applications, such as smart factories, smart grid, smart home, and connected cars. A network slicing platform may consist of multiple components with common target as mentioned below:
The network slicing platform may be centralized providing a common point for service configuration.
The network slicing platform may be able to create, modify and delete slices.
The network slicing platform may allow assigning single or multiple set of services to targeted enterprises.
The network slicing platform may be able to manage configuration within a defined set of network slice subnet.

The network slicing platform may include a Radio Access Network (RAN) (502), and a physical transport path (504) connecting the RAN (502) and the plurality of NFs. The plurality of NFs may include, but not limited to, a SMF (506), a User Plane Function (UPF) (508), an AMF (510), a NSSF (512), a Network Repository Function (NRF) (514), a PCF (516), and a UDM (518).

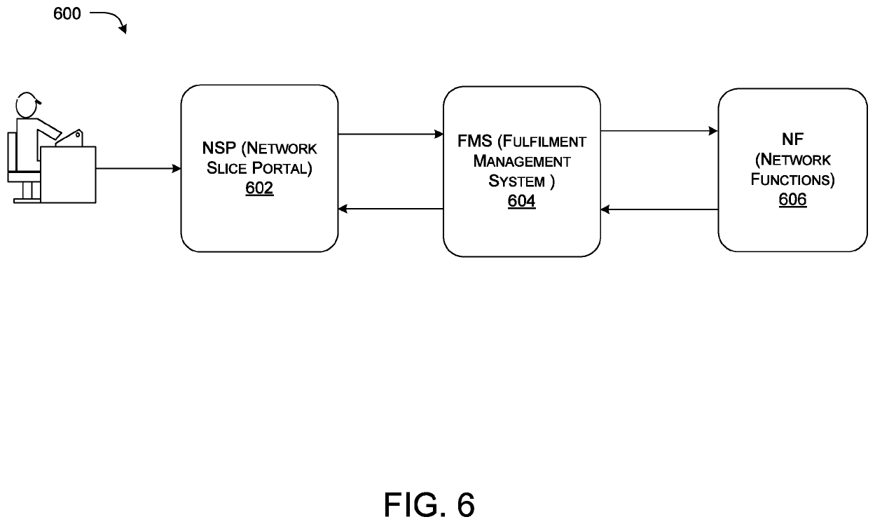

FIG. 6 illustrates an exemplary block diagram (600) of a generic slice creation flow, in accordance with embodiments of the present disclosure.

With reference to FIG. 6, as per user request, a NSP (602) may send global parameters and template data towards an FMS (604). Based on the request from the NSP (602), the FMS (604) may select a NF (606) and initiate respective APIs for provisioning the NF (606). The NF data may be provisioned and success/error may be reported back to the FMS (604). The FMS (604) may pass the report to the NSP (602).

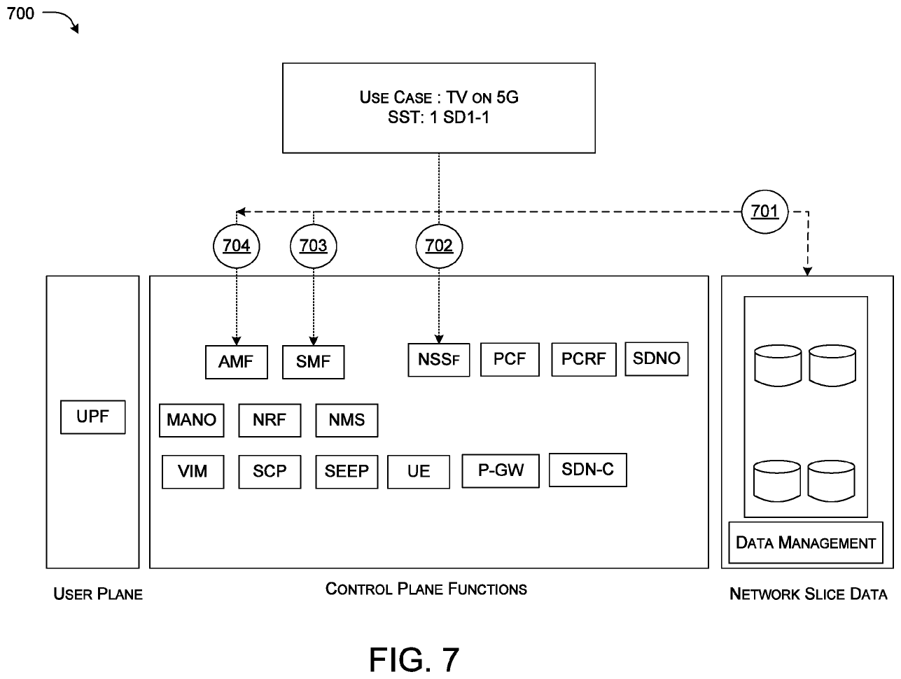

FIG. 7 illustrates an exemplary flow diagram (700) of network slice provisioning in 5G core network nodes through a NSP, in accordance with embodiments of the present disclosure.

With reference to FIG. 7, at 701, a NSP may create a subscriber provisioning template for specific slice which may be used to provision the subscribers in a UDM/UDR. At 702, the NSP may provision the NSSF with slice information. The slice information may be mapped with PLMN and TAI details. The NSSF may use the slice information to respond a NS selection request from an AMF. At 703, the NSP may provision a SMF with required slice information. At 704, the AMF may be provisioned in the last with slice data in the last by the NSP. As soon as the AMF provisioning is completed, slice may be available for the use.

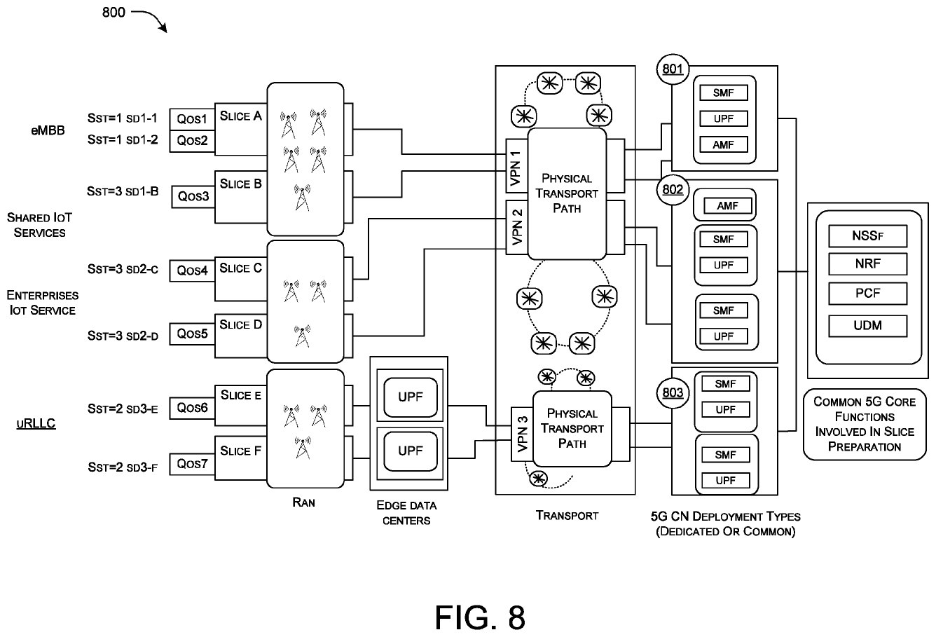

FIG. 8 illustrates an exemplary representation (800) of an advanced network slice architecture, in accordance with embodiments of the present disclosure.

With reference to FIG. 8, end-to-end slices may be prepared by exploiting slicing capabilities of an end-to-end network. The end-to-end network may perform control plane/user plane function (CP/UP), at 801. The end-to-end network may perform common AMF and dedicated SMF and UPF function, at 802. The end-to-end network may perform dedicated CP/UP functions, at 803.

Advanced NSP may include:
Integration of other NFs with the NSP, for example, PCF, Binding Support Function (BSF), UPF, and the like,
Enhancement in current flows based on a Third Generation Partnership Project (3GPP) specifications,
Integration with Management and Orchestration (MANO) platform for on demand orchestration of 5^{th} Generation Core Network (5GCN) based on slice requirement.
Transport slicing may not be done using the NSP, whether it may be a segregated platform or an integrated as part of the NSP.

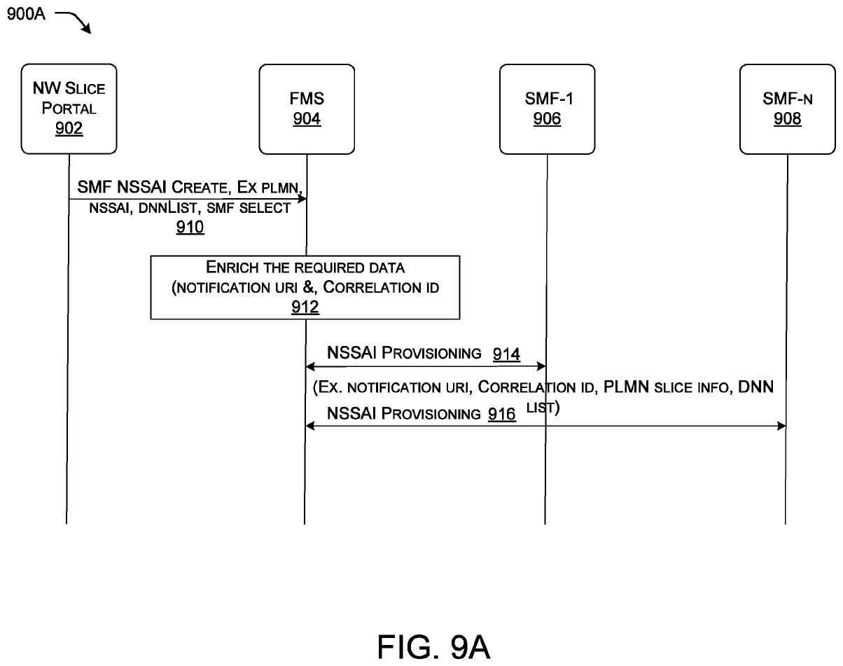

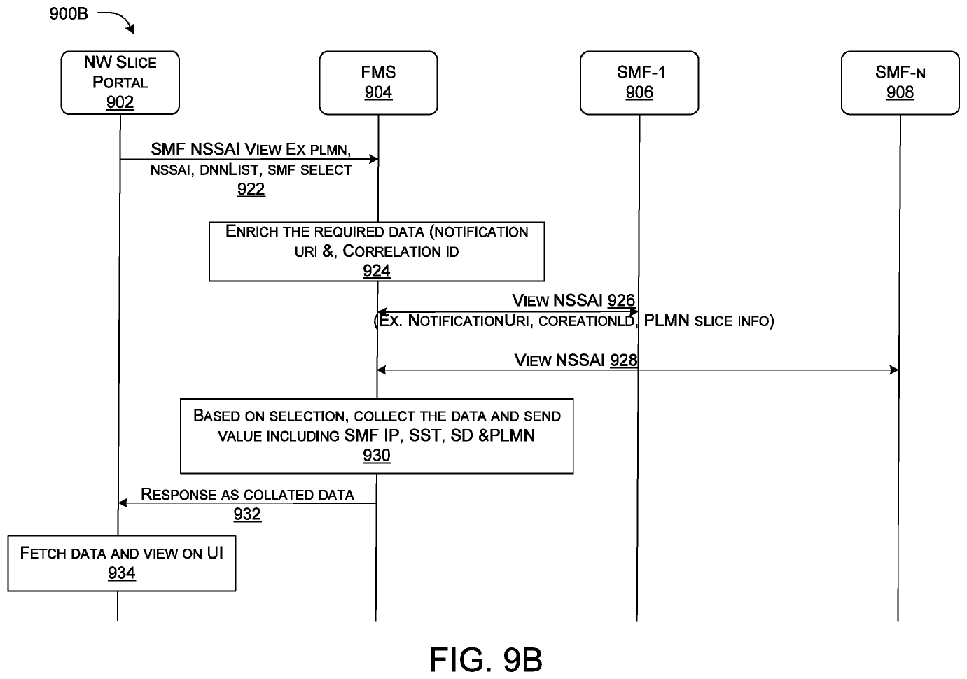

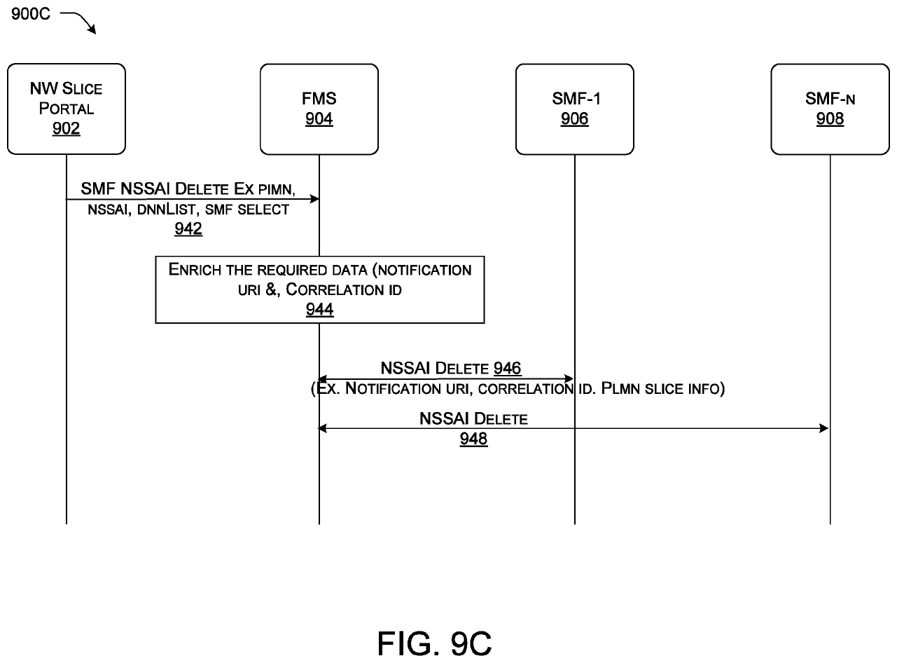

FIG. 9A illustrates an exemplary flow diagram (900A) of Session Management Function (SMF) and Network Slice Selection Assistance Information (NSSAI) create functions, in accordance with embodiments of the present disclosure.

With reference to FIG. 9A, a NSP (902) may send a SMF NSSAI create request to an FMS (904), at 910. The SMF NSSAI create request may include, but not limited to, PLMN, NSSAI, DNN list, and SMF select data. At 912, the FMS (904) may enrich the required data which includes a notification Uniform Resource Identifier (URI) and a correlation identifier (ID). At 914, the FMS (904) may perform NSSAI provisioning, for example but not limited to, the notification URI, the correlation ID, PLMN slice information, and DNN list to the SMF-1 (906), and receives the NSSAI provisioning from the SMF-1 (906). Further, at 916, the FMS (904) may perform NSSAI provisioning to a SMF-N (908), and receives the NSSAI provisioning from the SMF-N (908).

FIG. 9B illustrates an exemplary flow diagram (900B) of the SMF and the NSSAI view functions, in accordance with embodiments of the present disclosure.

With reference to FIG. 9B, a NSP (902) may send a SMF NSSAI view request to an FMS (904), at 922. The SMF NSSAI view request may include, but not limited to, PLMN, NSSAI, DNN list, and SMF select data. At 924, the FMS (904) may enrich the required data which includes a notification URI and a correlation ID. At 926, the FMS (904) may perform NSSAI view to view, for example but not limited to, the notification URI, the correlation ID, PLMN slice information, and DNN list to the SMF-1 (906). Further, at 928, the FMS (904) may perform NSSAI view to a SMF-N (908). At 930, based on selection, the FMS (904) may collect the data from the SMF-1 (906) and the SMF-N (908), and send a value including SMF Internet Protocol (IP), Slice/Service Type (SST), SD, and PLMN. At 932, the FMS (904) may send a response to the NSP (902) as collated data. At 934, the NSP (902) may fetch the data and view the data on UI.

FIG. 9C illustrates an exemplary flow diagram (900C) of the SMF and the NSSAI delete functions, in accordance with embodiments of the present disclosure.

With reference to FIG. 9C, a NSP (902) may send a SMF NSSAI delete request to an FMS (904), at 942. The SMF NSSAI delete request may include, but not limited to, PLMN, NSSAI, DNN list, and SMF select data. At 944, the FMS (904) may enrich the required data which includes a notification URI and a correlation ID. At 946, the FMS (904) may perform NSSAI delete function to delete, for example but not limited to, the notification URI, the correlation ID, PLMN slice information, and DNN list from the SMF-1 (906). Further, at 948, the FMS (904) may perform NSSAI delete function to delete, for example but not limited to, the notification URI, the correlation ID, PLMN slice information, and DNN list from the SMF-N (908).

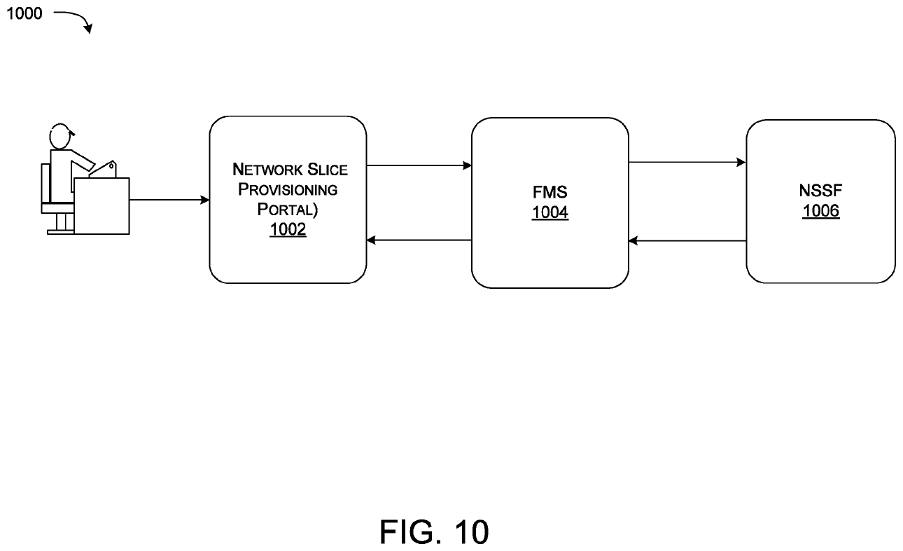

FIG. 10 illustrates an exemplary block diagram (1000) of the NSSF and Move, Add, Change, or Delete (MACD) flow, in accordance with embodiments of the present disclosure.

With reference to FIG. 10, the user may provide the plurality of parameters to a NSP (1002). The NSP (1002) may send the plurality of parameters received from the user to an FMS (1004). The FMS (1004) may perform create, delete, and view operations of the NSSF (1006). The create, delete, and view operation of the NSSF (1006) may be similar to the create, delete, and view operations of the AMF/SMF.

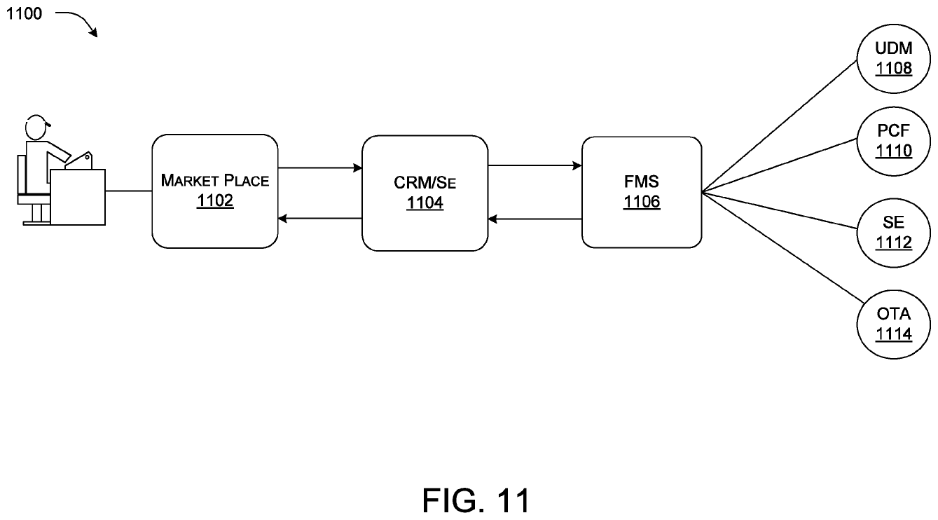

FIG. 11 illustrates an exemplary block diagram (1100) of a subscriber provisioning flow, in accordance with embodiments of the present disclosure.

With reference to FIG. 11, after selection of slice from a market place (1102), a subscriber for that enterprise may be on boarded from a market place UI. From the market place UI, an order request may be sent to a CRM lite (1104), and then to an FMS (1106). From the FMS (1106), it may be transferred to a UDM (1108), a PCF (1110), a subscription engine (1112), and an on-the-air (OTA). A Customer Acquisition Form (CAF)/address verification process may take place in the CRM lite (1104), and then order request may be forwarded to the FMS (1106). The order request may include enterprise ID (ENT ID). The FMS (1106) may perform correlation based on International Mobile Subscriber Identity (IMSI), ENT ID and service/slice being selected. The FMS (1106) may select subscription profile (since there is one to one mapping already created in Unified Inventory Management (UIM)) for enterprise subscriber and finally the FMS (1106) may provide the subscriber into the UDM (1108), the PCF (1110), the subscription engine (1112), or the OTA (1114).

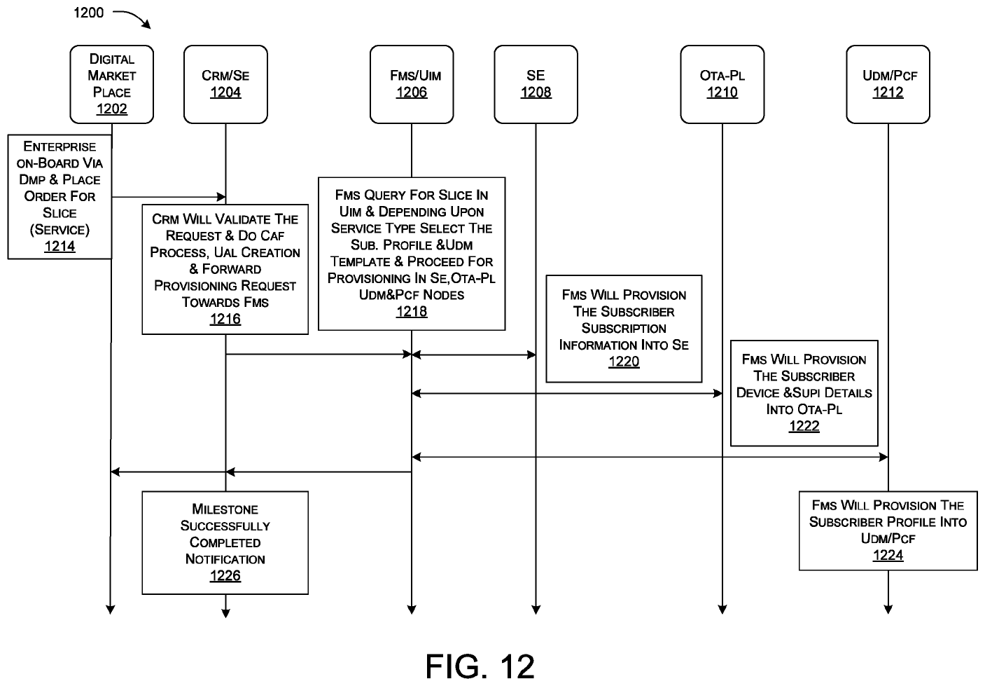

FIG. 12 illustrates an exemplary flow diagram (1200) of enterprise onboarding and subscriber provisioning workflow, in accordance with embodiments of the present disclosure.

With reference to FIG. 12, a digital market place (1202) may send a request regarding an enterprise on-board via a Data Management Platform (DMP) and place an order for slice (service) to a CRM (1204), at 1214. The CRM (1204) may validate the request and perform CAF process, UAL creation and forward provisioning request towards an FMS (1206), at 1216. The FMS (1206) may query for a slice in UIM, and may select a subscriber, a profile and a UDM template depending upon a service type. After selection, the FMS (1206) may proceed for provisioning in different nodes, at 1218. The FMS (1206) may provision a subscriber subscription information into a SE (1208), at 1220. The FMS (1206) may provision the subscriber device and Subscription Permanent Identifier (SUPI) details into an OTA-PL (1210), at 1222. The FMS (1206) may provision the subscriber profile into the UDM/PCF (1212), at 1224. Finally, the CRM (1204) may receive a milestone successfully completed notification from the FMS (1206).

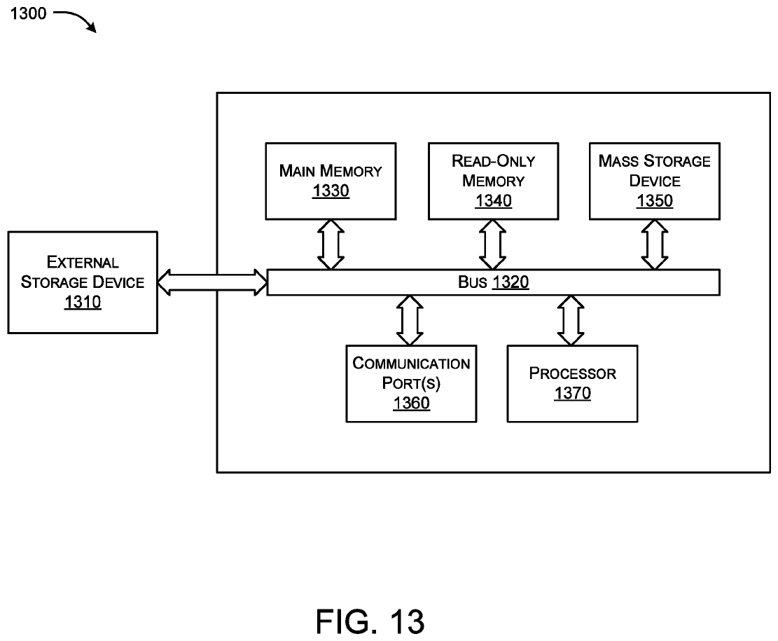

FIG. 13 refers to an exemplary computer system (1300) in which or with which embodiments of the present invention may be utilized, in accordance with embodiments of the present disclosure.

As shown in FIG. 13, the computer system (1300) may include an external storage device (1310), a bus (1320), a main memory (1330), a read only memory (1340), a mass storage device (1350), a communication port (1360), and a processor (1370).

A person skilled in the art will appreciate that the computer system (1300) may include more than one processor and communication ports. The processor (1370) may include various modules associated with embodiments of the present disclosure.

In an embodiment, the communication port (1360) may be any of an RS-232 port for use with a modem-based dialup connection, a 10/100 Ethernet port, a Gigabit or 10 Gigabit port using copper or fiber, a serial port, a parallel port, or other existing or future ports. The communication port (1360) may be chosen depending on a network, such a Local Area Network (LAN), Wide Area Network (WAN), or any network to which the computer system (1300) connects.

In an embodiment, the memory (1330) may be a Random Access Memory (RAM), or any other dynamic storage device commonly known in the art. The read-only memory (1340) may be any static storage device(s) e.g., but not limited to, a Programmable Read Only Memory (PROM) chips for storing static information e.g., start-up or Basic Input/Output system (BIOS) instructions for the processor (1370).

In an embodiment, the mass storage (1350) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus (1320) communicatively couples the processor(s) (1370) with the other memory, storage, and communication blocks. The bus (1320) may be, e.g., a Peripheral Component Interconnect (PCI)/PCI Extended (PCI-X) bus, Small Computer System Interface (SCSI), Universal Serial Bus (USB) or the like, for connecting expansion cards, drives, and other subsystems as well as other buses, such a front side bus (FSB), which connects the processor (1370) to computer system (1300).

Optionally, operator and administrative interfaces, e.g., a display, keyboard, joystick, and a cursor control device, may also be coupled to the bus (1320) to support direct operator interaction with the computer system (1300). Other operator and administrative interfaces may be provided through network connections connected through the communication port (1360). Components described above are meant only to exemplify various possibilities. In no way should the aforementioned exemplary computer system (1300) limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure provides a system and a method for integrating a network slicing entity with one or more Network Functions (NFs) in a wireless network.

The present disclosure standardizes a plurality of parameters required for network slicing, and tune/configures the plurality of parameters during network slicing.

The present disclosure provides a system and a method for network slicing by integrating the network slicing entity with a Network Slicing Selection Function (NSSF), an Access and Mobility Management Function (AMF), a Session Management Function (SMF), and a Policy Control Function (PCF).

The present disclosure assists in creation of slice service specific configuration in the network.

The present disclosure provides an enhancement in configuration of the network communication system.

We claim:

1. A system (110) for integrating a network slicing entity (108) with one or more Network Functions (NFs) in a wireless network, the system (110) comprising:
one or more processors (202); and
a memory (204) operatively coupled to the one or more processors (202), wherein the memory (204) comprises processor-executable instructions, which on execution, cause the one or more processors (202) to:
receive an input comprising a plurality of parameters from the network slicing entity (108) associated with a computing device (112);
perform provisioning of Network Slice Selection Function (NSSF) for slice configuration, and receive provisioning response from the NSSF, based on the plurality of parameters comprised in the received input;
perform in-sequence provisioning of Session Management Function (SMF) and Access and Mobility Management Function (AMF), and receive provisioning responses from the SMF and the AMF based on the provisioning response received from the NSSF indicating a success; and
integrate the network slicing entity (108) with the NSSF, the SMF, and the AMF to enable the network slicing entity (108) to generate a plurality of network slices based on the provisioning responses received from the SMF and AMF.

2. The system (110) as claimed in claim 1, wherein the plurality of parameters comprises at least one of: a Network Slice Selection Assistance Information (NSSAI), a Public Land Mobile Network (PLMN), a Tracking Area Code (TAC), a Tracking Area List (TAL), a Data Network Name (DNN), a Unified Data Management (UDM) template name, a restriction status, and a Network Slice Identifier (NSID) list.

3. The system (110) as claimed in claim 1, wherein the memory (204) comprises processor-executable instructions, which on execution, cause the one or more processors (202) to fetch information pertaining to interruption from a user interface associated with the system (110) based on the provisioning response received from the NSSF indicating a failure.

4. The system (110) as claimed in claim 1, wherein the memory (204) comprises processor-executable instructions, which on execution, cause the one or more processors (202) to separately perform Move, Add, Change, or Delete (MACD) functions for the NSSF, the SMF, the AMF, and a Unified Data Management (UDM) entity.

5. The system (110) as claimed in claim 4, wherein the one or more processors (202) are to perform the MACD functions for the NSSF by performing at least one of: adding a slice per Tracking Area Identity (TAI), creating a Network Slice Selection Assistance Information (NSSAI) mapping, enabling slice restriction for a roamer, enabling configured NSSAI provisioning, and providing supported Home Public Land Mobile Network (HPLMN) list and slice information.

6. The system (110) as claimed in claim 4, wherein the one or more processors (202) are to perform the MACD functions for the UDM using at least one of: Network Slice Selection Assistance Information (NSSAI), AMF subscription data, Data Network Name (DNN) configuration data, a DNN configuration map, SMF select data, a Communication Service (CoS) name, a Visited Public Land Mobile Network (VPLMN) list, a subscription profile, and template subscriber management data.

7. The system (110) as claimed in claim 1, wherein the provisioning response received from the NSSF, and the provisioning responses received from the SMF and the AMF comprise at least one of: a notification Uniform Resource Identifier (URI), a correlation Identifier (ID), and Public Land Mobile Network (PLMN) slice information.

8. The system (110) as claimed in claim 1, wherein the one or more processors (202) are to enable the network slicing entity (108) to generate the plurality of network slices by being configured to:
create a subscriber provisioning template for a specific slice which is used to provision one or more subscribers in a Unified Data Management (UDM) entity or a Unified Data Repository (UDR);
provide slice information mapped with Public Land Mobile Network (PLMN) and Tracking Area Identity (TAI) information to the NSSF based on the subscriber provisioning template;
provide the slice information to the SMF and the AMF in response to providing the slice information to the NSSF; and
generate the plurality of network slices once the provision of the slice information to the SMF and the AMF is complete.

9. A method for integrating a network slicing entity (108) with a plurality of Network Functions (NF) in a wireless network, the method comprising:
receiving, by a processor (202) associated with a system (110), an input comprising a plurality of parameters from the network slicing entity (108) associated with a computing device (112);
performing, by the processor (202), provisioning of Network Slice Selection Function (NSSF) for slice configuration, and receiving provisioning response from the NSSF, based on the plurality of parameters comprised in the received input;
performing, by the processor (202), in-sequence provisioning of Session Management Function (SMF) and Access and Mobility Management Function (AMF), and receiving provisioning responses from the SMF and the AMF based on the provisioning response received from the NSSF indicating a success; and
integrating, by the processor (202), the network slicing entity (108) with the NSSF, the SMF, and the AMF to enable the network slicing entity (108) to generate a plurality of network slices based on the provisioning responses received from the SMF and AMF.

10. The method as claimed in claim 9, wherein the plurality of parameters comprises at least one of: a Network Slice Selection Assistance Information (NSSAI), a Public Land Mobile Network (PLMN), a Tracking Area Code (TAC), a Tracking Area List (TAL), a Data Network Name (DNN), a Unified Data Management (UDM) template name, a restriction status, and a Network Slice Identifier (NSID) list.

11. The method as claimed in claim 9, comprising fetching, by the processor (202), information pertaining to interruption from a user interface associated with the system (110) based on the provisioning response received from the NSSF indicating a failure.

12. The method as claimed in claim 9, comprising separately performing, by the processor (202), Move, Add, Change, or Delete (MACD) functions for the NSSF, the SMF, the AMF, and a Unified Data Management (UDM) entity.

13. The method as claimed in claim 12, wherein performing the MACD functions for the NSSF comprises at least one of: adding a slice per Tracking Area Identity (TAI), creating a Network Slice Selection Assistance Information (NSSAI) mapping, enabling slice restriction for a roamer, enabling configured NSSAI provisioning, and providing supported Home Public Land Mobile Network (HPLMN) list and slice information.

14. The method as claimed in claim 12, wherein performing the MACD functions for the UDM comprises using at least one of: Network Slice Selection Assistance Information (NSSAI), AMF subscription data, Data Network Name (DNN) configuration data, a DNN configuration map, SMF select data, a Communication Service (CoS) name, a Visited Public Land Mobile Network (VPLMN) list, a subscription profile, and template subscriber management data.

15. The method as claimed in claim 9, wherein the provisioning response received from the NSSF, and the provisioning responses received from the SMF and the AMF comprise at least one of: a notification Uniform Resource Identifier (URI), a correlation Identifier (ID), and a Public Land Mobile Network (PLMN) slice information.

16. The method as claimed in claim 9, wherein enabling the network slicing entity (108) to generate the plurality of network slices comprises:
creating, by the processor (202), a subscriber provisioning template for a specific slice which is used to provision one or more subscribers in a Unified Data Management (UDM) entity or a Unified Data Repository (UDR);
providing, by the processor (202), slice information mapped with Public Land Mobile Network (PLMN) and Tracking Area Identity (TAI) information to the NSSF based on the subscriber provisioning template;
providing, by the processor (202), the slice information to the SMF and the AMF in response to providing the slice information to the NSSF; and
generating, by the processor (202), the plurality of network slices once the provision of the slice information to the SMF and the AMF is complete.

17. A non-transitory computer-readable medium comprising processor-executable instructions that cause a processor to:
receive an input comprising a plurality of parameters from a network slicing entity (108) associated with a computing device (112);
perform provisioning of Network Slice Selection Function (NSSF) for slice configuration, and receive provisioning response from the NSSF, based on the plurality of parameters comprised in the received input;
perform in-sequence provisioning of Session Management Function (SMF) and Access and Mobility Management Function (AMF), and receive provisioning responses from the SMF and the AMF based on the provisioning response received from the NSSF indicating a success; and
integrate the network slicing entity (108) with the NSSF, the SMF, and the AMF to enable the network slicing entity (108) to generate a plurality of network slices based on the provisioning responses received from the SMF and the AMF.
